(19) United States
(12) Patent Application Publication
(10) Pub. No.: US 2023/0289592 A1
(43) Pub. Date: Sep. 14, 2023

(54) METHOD AND SYSTEM FOR GENERATING A TRAINING DATASET

(71) Applicant: MOBIUS LABS GMBH, Berlin (DE)

(72) Inventors: Hicham BADRI, Berlin (DE); Aleksandr MOVCHAN, Berlin (DE); Appu SHAJI, Berlin (DE)

(21) Appl. No.: 18/007,263

(22) PCT Filed: Jun. 29, 2021
(86) PCT No.: PCT/EP2021/067843

§ 371 Date: Jan. 27, 2023

(30) Foreign Application Priority Data
Jul. 28, 2020 (EP) 20188165.3

(51) Int. Cl. G06N 3/08

(52) U.S. Cl. CPC G06N 3/08

(57) ABSTRACT

Disclosed are methods and systems for generating and using a dataset for training a classifier algorithm. The method comprises inputting a sample dataset into an annotation module; the annotation module ranking a benchmark dataset based on the sample dataset; based on the ranking, the annotation module outputting a subset of the benchmark dataset ranked within a predetermined similarity threshold to the sample dataset; generating a training dataset by adding the subset of the benchmark dataset to the sample dataset; a classification module using the training dataset to train the classifier algorithm. The system comprises a database comprising at least a benchmark dataset; an annotation module configured to receive a sample dataset, rank a benchmark dataset based on the sample dataset; based on the ranking, output a subset of the benchmark dataset ranked within a predetermined similarity threshold to the sample dataset, generate a training dataset by adding the subset of the benchmark dataset to the sample dataset; and a classification module configured to use training dataset to train the classifier algorithm.

### FIELD

The invention relates to generating datasets. More particularly, the invention relates to generating a training dataset and training a neural network with it.

### INTRODUCTION

The use of datasets for various purposes has been on the rise. Various annotated and labeled datasets are commonly used to train neural networks which can then be used for purposes such as classifying new incoming data. Such datasets typically need to be fairly large and structured to achieve good training results. For example, a common use of neural networks trained with such datasets is to classify images.

For instance, international patent application WO 2017/134519 A4 discloses a method of training an image classification model which includes obtaining training images associated with labels, where two or more labels of the labels are associated with each of the training images and where each label of the two or more labels corresponds to an image classification class. The method further includes classifying training images into one or more classes using a deep convolutional neural network, and comparing the classification of the training images against labels associated with the training images. The method also includes updating parameters of the deep convolutional neural network based on the comparison of the classification of the training images against the labels associated with the training images.

It may be difficult to obtain large annotated and labeled datasets for a particular use case. In other words, if a neural network is to be used for a certain purpose, the dataset that it is trained with should also be tailored for such purpose. However, producing such datasets or obtaining access to them is often difficult.

Some techniques have been previously investigated. For example US patent application 2002/0147694 A1 provides a method and apparatus for retraining a trainable data classifier (for example, a neural network). Data provided for retraining the classifier is compared with training data previously used to train the classifier, and a measure of the degree of conflict between the new and old training data is calculated. This measure is compared with a predetermined threshold to determine whether the new data should be used in retraining the data classifier. New training data which is found to conflict with earlier data may be further reviewed manually for inclusion.

Further, U.S. Pat. No. 6,298,351 B1 discloses an unreliable training set that is modified to provide for a reliable training set to be used in supervised classification. The training set is modified by determining which data of the set are incorrect and reconstructing those incorrect data.

The reconstruction includes modifying the labels associated with the data to provide for correct labels. The modification can be performed iteratively.

Additionally, treating noisy data is discussed in Han, J., Luo, P., & Wang, X. (2019). Deep self-learning from noisy labels. In Proceedings of the IEEE International Conference on Computer Vision (pp. 5138-5147). The authors disclose that learning from noisy labels significantly degrades performances and remains challenging. Unlike previous works constrained by many conditions, making them infeasible to real noisy cases, this work presents a novel deep self-learning framework to train a robust network on the real noisy datasets without extra supervision.

### SUMMARY

It is the object of the present invention to provide an improved and reliable way to generate training datasets. It is also the object to provide a novel procedure for increasing datasets based on small sample datasets. It is further the aim to disclose system and methods for generating training datasets and training neural networks based on them.

In a first embodiment, a method for generating and using a dataset for training a classifier algorithm is disclosed. The method comprises inputting a sample dataset into an annotation module. The method also comprises the annotation module ranking a benchmark dataset based on the sample dataset. The method further comprises, based on the ranking, the annotation module outputting a subset of the benchmark dataset ranked within a predetermined similarity threshold to the sample dataset. The method also comprises generating a training dataset by adding the subset of the benchmark dataset to the sample dataset. The method further comprises a classification module using the training dataset to train the classifier algorithm.

The present method can be advantageously used to expand a sample dataset that may be small or noisy on the basis of other existing datasets (benchmark datasets). The datasets need not be labelled, and can simply comprise a large amount of unstructured data, which can be compared to the sample dataset. Elements that are then identified as most similar to those of the sample dataset can be selected to expand the sample dataset and obtain a training dataset.

There may be a quality control of the identified elements of the benchmark dataset to ensure that they are indeed fitting for the sample dataset. This optional step may be performed by a quality controller or the like.

The sample dataset may also be analyzed to see if any elements should be removed, i.e. in the case of messy or noisy data. In this way, the sample dataset can also be filtered, and outliers or elements falling below certain thresholds can be removed.

In one specific example, it may be desirable to train a parrot classifier. A sample dataset of parrot images may be small, such as only a few (e.g. 10-100) images of parrots. The present method can then be used to take a large dataset of birds or even animal pictures, and compare it with the sample dataset to identify images that might also comprise parrots. All of the images of the benchmark dataset may be ranked, and the highest ranked images would then correspond to the ones most likely showing parrots. These images from the benchmark dataset can then be added to the small sample dataset to increase it. If some of the high ranked images are discovered to not be parrots (e.g. via quality control), but instead, for example, contain pigeons, those can also be input as part of the ranking step as negative inputs (i.e. images similar to the negative ones will be assigned a lower respective ranking).

In some embodiments, the method can further comprise quality-controlling the output subset of the benchmark dataset prior to generating the training dataset. As mentioned above this can be done via a quality controller (e.g. a human in the loop) or automatically by more stringent comparisons with known positives. The quality control advantageously allows to reduce the number of false positives and to ensure that the training dataset is as clean and accurate as possible.

In some such embodiments, the method can further comprise re-ranking the benchmark dataset and outputting a modified subset of the benchmark dataset if the quality-controlling fails. In other words, if the first output is not sufficiently clean or does not pass the quality control in some other way, the ranking step may be repeated, e.g. with further parameters, weights, negative weights or the like. This can be very useful for generating a particularly clean dataset and to ensure that any issues with the ranking can be addressed and corrected.

In some such embodiments, the method can further comprise outputting a modified subset of the benchmark dataset by adjusting the predetermined similarity threshold if the quality-controlling fails. For example, if the first 10 top ranked images are fitting with the sample dataset, but the first 100 are not, the similarity threshold for adding images from the benchmark dataset into the sample dataset might be adjusted to be higher, so that fewer of the top ranked results are added and the resulting dataset is cleaner. Although this would lead to a smaller training dataset, the ranking step can be repeated with the slightly expanded sample dataset (i.e. with only the top 10 ranked images of the benchmark dataset), and further candidates for expanding the sample dataset can be selected based on this slightly larger sample dataset. In other words, building the training dataset may be achieved over several “rounds” of ranking the benchmark dataset and adding top results to the sample dataset, with each round slowly expanding resulting the training dataset.

In some embodiments, the method can further comprise inputting the training dataset to the annotation module and repeating the ranking and output steps to output a second subset of the benchmark dataset and generate a second training set by combining the second subset of the benchmark dataset with the training set. As also discussed above with regard to the previous embodiment, this step (independent of the quality control-related embodiments) can allow to build the training dataset step by step and ensure that it comprises truly appropriate elements. In other words, false positives can be minimized without compromising on the overall number of elements in the training dataset.

In some embodiments, the method can further comprise additionally inputting a negative dataset into the annotation module. The negative dataset may comprise elements that are not representative of those of a sample dataset. In other words, the elements of the negative dataset may correspond to elements that should not be part of the training dataset. For example, using the above specific case of training a parrot classifier, the negative dataset may comprise images of pigeons (so that the pigeons do not end up as part of the training dataset for parrots).

In some such embodiments, the method can further comprise assigning lower rank to constituents of the benchmark dataset based on similarity to constituents of the negative dataset. That is, elements or constituents of the benchmark dataset that are close or similar to those of the negative dataset would be less likely to be selected to be added to the training dataset. In this way, groups or classes of elements that are not desirable in the training dataset can be specifically excluded from it.

In some such embodiments, the method can further comprise simultaneously ranking the benchmark dataset based on the sample dataset and the deterrence dataset and removing any constituents of the output subset of the benchmark dataset ranking within a predetermined similarity threshold to the deterrence dataset. This can allow to advantageously reduce the number of false positives that end up being added to the training dataset.

In some embodiments, the sample dataset can comprise constituents comprising images. In other words, the present method can be preferably used to generate and use training datasets comprising images such as photos, frames of videos, computer-generated images or the like.

In some embodiments, the sample dataset constituents can be at least partially annotated. In some such embodiments, the method can further comprise using the annotations of the sample dataset as part of the ranking of the benchmark dataset. This can be done, for example, by using the annotations as weights in the ranking process or by ranking separately based on different classes present within the sample dataset.

In some embodiments, the benchmark dataset can comprise constituents comprising images. As described above, the images might comprise photos, video frames, screenshots, computer-generated images or the like.

In some embodiments the benchmark dataset can comprise at least partially unannotated constituents. This can advantageously allow to use larger benchmark dataset, since it is typically hard to fully annotate very large datasets.

In some embodiments, the sample dataset can comprise seed data. The seed data can comprise pre-assigned annotations. The seed data can comprise at least one of noisy data, incomplete data and unannotated data.

In some embodiments, the training dataset can comprise less noise than the sample dataset. That is, the training dataset may be cleaner or comprise more elements fitting the parameters required for the training dataset. It can comprise less false positives as well.

In some embodiments, the training dataset can comprise more annotations than the sample dataset. Advantageously, this may make the training dataset more structured and therefore more suitable for training a classifier algorithm.

In some embodiments, the training dataset can comprise more constituents and/or negative constituents than the sample dataset. In other words, the training dataset is preferably an expansion of the sample dataset with additional elements or constituents added from the benchmark dataset. Furthermore, additional negative elements can also be added if they are detected in the benchmark dataset.

In some embodiments, the annotation module can comprise a neural network. The neural network can be, for example, a convolutional neural network. Using NN for ranking the benchmark dataset based on the sample dataset allows for obtaining robust results which lead to an improved training dataset.

In some such embodiments, the method can further comprise training the neural network on the sample dataset and using it to output the subset of the benchmark dataset once trained. In some such embodiments, the annotation module can comprise a convolutional neural network.

In some such embodiments, the method can further comprise the annotation module using a loss function to rank the benchmark dataset. The loss function can comprise a part configured to rank constituents of the benchmark dataset most similar to constituents of the sample dataset higher than the rest and a part configured to rank undesirable constituents as lower than the rest. In other words, the loss function can be described mathematically as a function made up of two separate functions, which are added together.

In some such embodiments, undesirable constituents can be determined by their similarity to the negative dataset. In other words, the sub-function or part of the loss function acting as a detriment or suppresser for the undesirable constituents can be based on elements or constituents of the negative dataset if it is present.

In some embodiments, the annotation module can comprise at least one of Bayesian algorithm, Non-linear machine learning algorithm, casual machine learning algorithm, Evolutionary algorithm, and Genetic algorithm. A mix of those can be used as well.

In some embodiments, the classifier algorithm can comprise a classification neural network and the method can further comprise training the classification neural network by using the generated training dataset.

In some such embodiments, the training can comprise inputting the training dataset into a classification neural network and training the classification neural network to classify data based on the training dataset.

In some such embodiments, the method can further comprise retraining the classification neural network with the training dataset and a different loss function and comparing obtained results. In other words, various types of training can be used given a certain training dataset. The results can then be compared and a better one selected.

In some such embodiments, the method can further comprise retraining the classification neural network with the training dataset and a different sampling strategy and comparing obtained results.

In some such embodiments, the method can further comprise using the trained classification neural network to classify a new input. The new input may comprise a dataset and/or an element or a constituent that should be classified via the training NN.

In some such embodiments, the trained classification neural network can be used to classify images. In some preferred embodiments, the images can comprise human faces. For example, the present method can be used to classify a series of photos or selfies and select one where a person (and or multiple persons) are smiling.

In a second embodiment, a system for generating and using a dataset for training a classifier algorithm is disclosed. The system comprises a database comprising at least a benchmark dataset. The system also comprises an annotation module configured to receive a sample dataset and rank a benchmark dataset based on the sample dataset. The annotation module is further configured to output a subset of the benchmark dataset ranked within a predetermined similarity threshold to the sample dataset based on the ranking and to generate a training dataset by adding the subset of the benchmark dataset to the sample dataset. The system further comprises a classification module configured to use the training dataset to train the classifier algorithm.

Similarly to the above method, the present system can be advantageously used to improve small or noisy datasets and then use them to train classifiers. The present system (as well as the method) can be implemented on a processor and run by a computer.

In some embodiments, the system can further comprise a quality control module configured to quality-control the output subset of the benchmark dataset prior to the generator module generating the training dataset. The quality control module may be automatic and/or operator-controlled. In the latter case, it may comprise an interface that can be used by an operator to evaluate the training dataset and see if its quality is acceptable.

In some embodiments, the annotation module can be further configured to receive a negative dataset and reject candidates for subset of the benchmark dataset based on the negative dataset. As also explained above, this can minimize the occurrence of false positives (e.g. occurrences of pigeons among the pictures of parrots that are desired).

In some such embodiments, the annotation module can be further configured to simultaneously rank the benchmark dataset based on the sample dataset and the negative dataset and rank any constituents of the output subset of the benchmark dataset ranking within a predetermined similarity threshold to the negative dataset relatively lower than the constituents outside of the predetermined similarity threshold.

In some embodiments, the sample dataset can comprise constituents comprising images. These can be as described above in relation to the method embodiments.

In some embodiments, the sample dataset constituents can be at least partially annotated. In such embodiments, the annotation module can be further configured to use the annotations of the sample dataset as part of the ranking of the benchmark dataset.

In some embodiments, the benchmark dataset can comprise constituents comprising images.

In some embodiments, the benchmark dataset can comprise at least partially unannotated constituents.

In some embodiments, the annotation module can comprise a neural network.

In some embodiments, the classifier algorithm can comprise a classification neural network and the classification module can be configured to input the training dataset into the classification neural network and train the classification neural network to classify data based on the training dataset.

In some such embodiments, the trained classification neural network can be configured to classify new inputs. Such new inputs can comprise, for example, images.

The present system and all the above preferred embodiments can be configured to carry out the method according to any of the preceding method embodiments.

The present invention is also defined by the following numbered embodiments.

### EMBODIMENTS

Below is a list of method embodiments. Those will be indicated with a letter “M”. Whenever such embodiments are referred to, this will be done by referring to “M” embodiments.

M1. A method for generating and using a dataset for training a classifier algorithm, the method comprising
Inputting a sample dataset into an annotation module;
The annotation module ranking a benchmark dataset based on the sample dataset;
Based on the ranking, the annotation module outputting a subset of the benchmark dataset ranked within a predetermined similarity threshold to the sample dataset;
Generating a training dataset by adding the subset of the benchmark dataset to the sample dataset;
A classification module using the training dataset to train the classifier algorithm.

Embodiments Relating to Quality Assurance of the Output Dataset/Running the Annotation Module Multiple Times

M2. The method according to the preceding embodiment further comprising quality-controlling the output subset of the benchmark dataset prior to generating the training dataset.

M3. The method according to the preceding embodiment further comprising re-ranking the benchmark dataset and outputting a modified subset of the benchmark dataset if the quality-controlling fails.

M4. The method according to any of the two preceding embodiments further comprising outputting a modified subset of the benchmark dataset by adjusting the predetermined similarity threshold if the quality-controlling fails.

M5. The method according to any of the preceding embodiments further comprising inputting the training dataset to the annotation module and repeating the ranking and output steps to output a second subset of the benchmark dataset and generate a second training set by combining the second subset of the benchmark dataset with the training set.

Embodiments Relating to Reducing False Positives in the Output Dataset

M6. The method according to any of the preceding embodiments further comprising additionally inputting a negative dataset into the annotation module.

M7. The method according to the preceding embodiment further comprising assigning lower rank to constituents of the benchmark dataset based on similarity to constituents of the negative dataset.

M8. The method according to any of the two preceding embodiments further comprising simultaneously ranking the benchmark dataset based on the sample dataset and the negative dataset and removing any constituents of the output subset of the benchmark dataset ranking within a predetermined similarity threshold to the negative dataset.

Embodiments Relating to the Types of Data within Datasets

M9. The method according to any of the preceding method embodiments wherein the sample dataset comprises constituents comprising images.

M10. The method according to any of the preceding method embodiments wherein the sample dataset constituents are at least partially annotated.

M11. The method according to the preceding embodiment further comprising using the annotations of the sample dataset as part of the ranking of the benchmark dataset.

M12. The method according to any of the preceding embodiments wherein the benchmark dataset comprises constituents comprising images.

M13. The method according to any of the preceding embodiments wherein the benchmark dataset comprises at least partially unannotated constituents.

M14. The method according to any of the preceding embodiments wherein the sample dataset comprises seed data.

M15. The method according to the preceding embodiment wherein the seed data comprises pre-assigned annotations.

M16. The method according to any of the two preceding embodiments wherein the seed data comprises at least one of noisy data, incomplete data and unannotated data.

M17. The method according to any of the preceding embodiments wherein the training dataset comprises less noise than the sample dataset.

M18. The method according to any of the preceding embodiments wherein the training dataset comprises more annotations than the sample dataset.

M19. The method according to any of the preceding embodiments wherein the training dataset comprises more constituents and/or negative constituents than the sample dataset.

Embodiments Relating to the Annotation Module Architecture

M20. The method according to any of the preceding embodiments wherein the annotation module comprises a neural network.

M21. The method according to the preceding embodiment further comprising training the neural network on the sample dataset and using it to output the subset of the benchmark dataset once trained.

M22. The method according to any of the two preceding embodiments wherein the annotation module comprises a convolutional neural network.

M23. The method according to any of the three preceding embodiments further comprising the annotation module using a loss function to rank the benchmark dataset.

M24. The method according to the preceding embodiment wherein the loss function comprises a part configured to rank constituents of the benchmark dataset most similar to constituents of the sample dataset higher than the rest and a part configured to rank undesirable constituents as lower than the rest.

M25. The method according to the preceding embodiment and with features of embodiment M6 wherein undesirable constituents are determined by their similarity to the negative dataset.

M26. The method according to any of the preceding embodiments wherein the annotation module comprises at least one of
Bayesian algorithm;
Non-linear machine learning algorithm;
casual machine learning algorithm;
Evolutionary algorithm; and
Genetic algorithm.

Embodiments Relating to Further Use of the Output Training Dataset in a Neural Network

M27. The method according to any of the preceding embodiments wherein the classifier algorithm comprises a classification neural network and wherein the method further comprises training the classification neural network by using the generated training dataset.

M28. The method according to the preceding embodiment wherein the training comprises Inputting the training dataset into a classification neural network; and Training the classification neural network to classify data based on the training dataset.

M29. The method according to any of the two preceding embodiments further comprising retraining the classification neural network with the training dataset and a different loss function and comparing obtained results.

M30. The method according to any of the three preceding embodiments further comprising retraining the classification neural network with the training dataset and a different sampling strategy and comparing obtained results.

M31. The method according to any of the four preceding embodiments further comprising using the trained classification neural network to classify a new input.

M32. The method according to the preceding embodiment wherein the trained classification neural network is used to classify images.

M33. The method according to the preceding embodiment wherein the images comprise human faces.

Below is a list of system embodiments. Those will be indicated with a letter “5”. Whenever such embodiments are referred to, this will be done by referring to “5” embodiments.

S1. A system for generating and using a dataset for training a classifier algorithm, the system comprising
A database comprising at least a benchmark dataset;
An annotation module configured to
   Receive a sample dataset;
   Rank a benchmark dataset based on the sample dataset;
   Based on the ranking, output a subset of the benchmark dataset ranked within a predetermined similarity threshold to the sample dataset;
   Generate a training dataset by adding the subset of the benchmark dataset to the sample dataset; and
A classification module configured to use the training dataset to train the classifier algorithm.

S2. The system according to the preceding embodiment further comprising a quality control module configured to quality-control the output subset of the benchmark dataset prior to the generator module generating the training dataset.

S3. The system according to any of the preceding system embodiments wherein the annotation module is further configured to receive a negative dataset and reject candidates for subset of the benchmark dataset based on the negative dataset.

S4. The system according to the preceding embodiment wherein the annotation module is further configured to simultaneously rank the benchmark dataset based on the sample dataset and the negative dataset and rank any constituents of the output subset of the benchmark dataset ranking within a predetermined similarity threshold to the negative dataset relatively lower than the constituents outside of the predetermined similarity threshold.

S5. The system according to any of the preceding system embodiments wherein the sample dataset comprises constituents comprising images.

S6. The system according to any of the preceding system embodiments wherein the sample dataset constituents are at least partially annotated.

S7. The system according to the preceding embodiment wherein the annotation module is further configured to use the annotations of the sample dataset as part of the ranking of the benchmark dataset.

S8. The system according to any of the preceding system embodiments wherein the benchmark dataset comprises constituents comprising images.

S9. The system according to any of the preceding system embodiments wherein the benchmark dataset comprises at least partially unannotated constituents.

S10. The system according to any of the preceding system embodiments wherein the annotation module comprises a neural network.

S11. The system according to any of the preceding system embodiments wherein the classifier algorithm comprises a classification neural network and wherein the classification module is configured to
Input the training dataset into the classification neural network; and
Train the classification neural network to classify data based on the training dataset.

S12. The system according to the preceding embodiment wherein the trained classification neural network is configured to classify new inputs.

S13. The system according to the preceding embodiment wherein new inputs comprise images.

S14. The system according to any of the preceding embodiments configured to carry out the method according to any of the preceding method embodiments.

The present technology will now be discussed with reference to the accompanying drawings.

### BRIEF DESCRIPTION OF THE DRAWINGS

FIG. 1 schematically depicts an embodiment of a method for generating a training dataset;

FIG. 2 depicts the above method with several optional steps outlined;

FIG. 3 schematically depicts a system for generating a training dataset, with several optional elements/components shown as well;

FIG. 4 schematically shows an advantage of the present method and system compared to the prior art.

### DESCRIPTION OF EMBODIMENTS

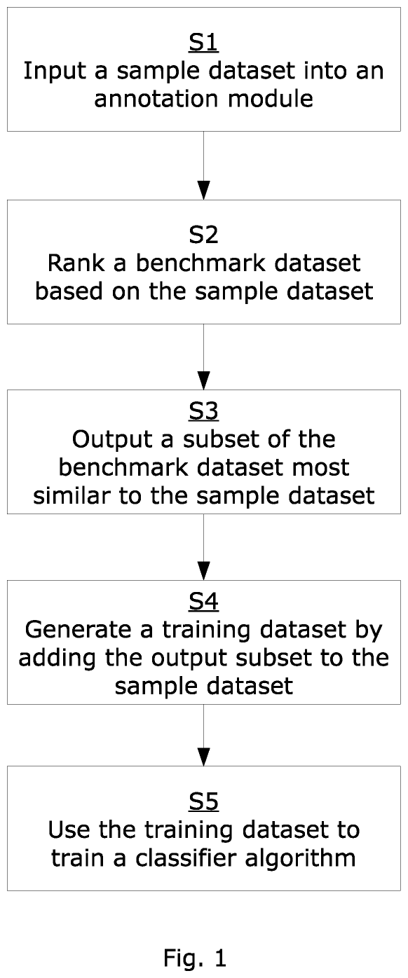

FIG. 1 schematically depicts an embodiment of a method for generating a training dataset according to an aspect of the present invention.

Described is a series of steps that result in generation of dataset that can be used e.g. for training a classifier (such as a classification neural network). The present method is particularly useful for cases where only a small dataset is initially available for the purpose. Training accurate machine learning models often requires having access to a large clean and annotated dataset of positive and negative examples, which can be fairly difficult to obtain. In contrast, noisy or incomplete data can be much easier to obtain. The present method can use noisy or incomplete data to train more accurate models. The advantageous process offers an end-to-end approach from initial data gathering to a final well-trained classifier to be used in production.

For example, if it is desired to select specific facial expressions from a dataset with a plurality of human faces, it might be the case that only a small annotated or labelled set is available that can be used to train the neural network. If this set is used, the resulting neural network might not yield sufficiently good results when classifying new images with human faces. The present procedure can advantageously allow to expand the available small (and/or messy) dataset with images from a larger, but potentially unlabeled/not annotated dataset.

In a first step, S1, a sample dataset is input into an annotation module. The sample dataset may be relatively small (such as e.g. it might not be sufficient for training a neural network on its own) and/or it may be messy (e.g. with false positives, errors in labels or annotations etc). The sample dataset may comprise constituents (that is, objects that form the dataset). In one particular example, the constituents might comprise images with optional labels and/or annotations.

The annotation module may comprise a subroutine of a general algorithm or procedure that can be computer implemented. The annotation module may comprise a neural network-based algorithm, or it can also comprise a different type of algorithm. The annotation module serves to receive a certain type of data (e.g. the sample dataset), use it in certain ways and then output a certain type of data. The annotation module can advantageously allow to find data similar to constituents of the sample dataset, so that it can be expanded and therefore become more suitable for training a neural network.

In a second step, S2, a benchmark dataset is ranked based on the sample dataset. The benchmark dataset may be stored in a database that is part of the computer-implemented method. For example, the database might be accessed by a central server or a computing/processing component, and the benchmark dataset processed by the annotation module.

The ranking of the benchmark dataset may be performed in different ways. In one example, the constituents of the sample dataset are processed and evaluated, and each constituent of the benchmark dataset may be compared with them, to determine how similar it is. In other words, the ranking may output a certain probability that the benchmark dataset constituent is similar to the sample dataset constituents. In a specific example of considering expressions on human faces, the sample dataset might comprise 10 images of smiling human faces. The benchmark dataset might comprise millions of images, some of which might comprise human faces, some of which might be smiling. The ranking performed by the annotation module would then place the constituents of the benchmark dataset comprising smiling human faces relatively higher compared to the constituents without human faces and/or with different expressions.

In step S3, the annotation module outputs a subset of the benchmark dataset that is most similar to the sample dataset. This can mean that top X number of constituents ranked as most similar or closest to the sample dataset are output. The size of the output subset may be variable. In other words, it may be advantageous to adjust a threshold where all constituents ranked above it would be output as part of the subset. This threshold may be set based on the desired total size of the training dataset (e.g. at least 1000 images necessary to appropriately train a neural network in a given use case), and/or other factors. For example, the threshold may also be adjusted if a quality control determined that the output subset is either too noisy, too small/large or the like.

In step S4, a training dataset is generated. The generation is done by adding the output subset to the sample dataset. When the two are combined, the data of each dataset can also be transformed so as to allow for consistent handling of the resulting training dataset. In other words, labels or annotations might be added to some data, it may be transformed from one format to another and it may be adjusted to ensure that it can be handled smoothly.

The resulting training dataset can be advantageously significantly larger than its originating sample dataset. It can also be expanded further by running it through the annotation module again for as long as needed to obtain a sufficiently sized dataset.

In step S5, the training dataset is used to train a classifier algorithm. The classifier algorithm may comprise a classification neural network. The training might be performed with different loss functions until a satisfactory result is achieved.

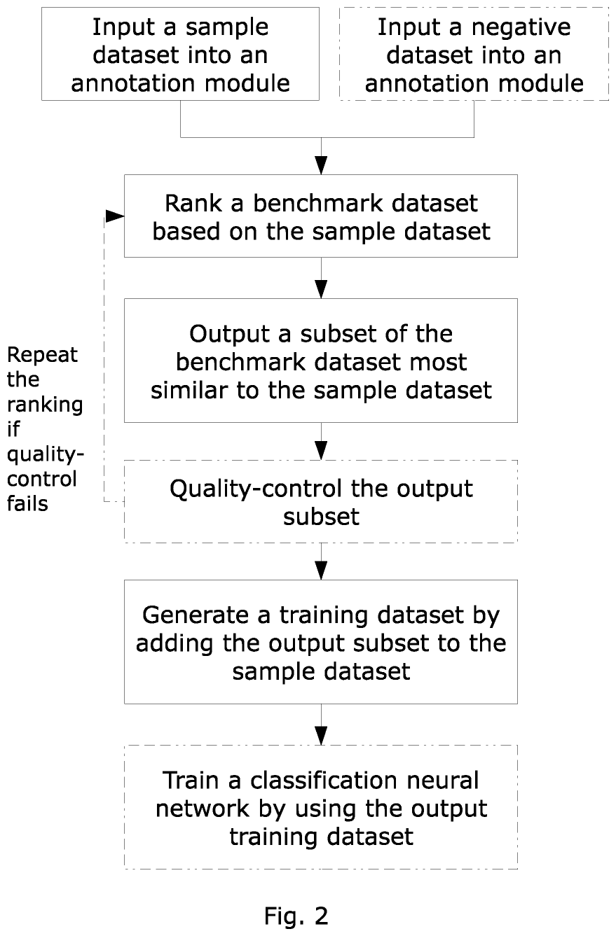

FIG. 2 schematically depicts the present advantageous method for generating a training dataset with a plurality of optional steps or subroutines outlined. The optional steps/subroutines are indicated by dashed lines. As before, a sample dataset is input into an annotation module. However, an optional negative dataset can also be input into the annotation module. The negative dataset may comprise constituents that would not be desirable as part of the output subset. For example, if the sample dataset comprises images of smiling faces, the negative dataset might comprise frowning faces. In another example, the sample dataset may comprise images of parrots. The goal would be to expand the training dataset to obtain a training dataset with further pictures of parrots. The negative dataset may then comprise pictures of pigeons. It would be disadvantageous if the output dataset comprised pictures of pigeons along with pictures of parrots, and therefore inputting the negative dataset may improve the quality of the resulting training dataset and reduce false positives in it.

The annotation module ranks the benchmark dataset based on the sample dataset and optionally based on the negative dataset. For example, if the annotation module is implemented as a convolutional neural network, a loss function comprising a part rewarding closeness or similarity to the constituents of the sample dataset and a part punishing closeness or similarity to the constituents of the negative dataset could be used. Using the two parts of the loss function can then allow for more precise output and therefore a “cleaner” resulting training dataset.

An exemplary loss function may comprise, for example, the following:

$${L}_{A} ( y , {y}^{-} , \hat{y} ) = {\sum }_{j = 1}^{n} {\sum }_{i = 1}^{n} 1 ( {y}_{j} > {y}_{i} ) log ( 1 + exp ( \hat{{γ}_{ι}} - \hat{{y}_{J}} ) ) - λ {\sum }_{i = 1}^{n} 1 ( {y}_{i}^{-} = 1 ) log ( 1 - \hat{{y}_{ι}} )$$

Where, in the above, the part within the rectangle ensures that positive constituents of the benchmark dataset are ranked higher than the rest, and the other part (outside of the rectangle) serves to push hard-negatives down in the ranking.

In the above,
y corresponds to the ground-truth labels for positives or unlabeled samples
y-corresponds to the ground-truth labels for hard-negative samples
y\hat{ } corresponds to the predicted scores of the annotation module model
λ is positive parameter
1(condition) is 1 if condition is true, 0 otherwise.

Once the subset of the benchmark dataset is output, is can be optionally quality-controlled via a quality control module. This can be done manually and/or automatically. The quality of the output subset can be investigated to determine whether it truly corresponds to the input sample dataset. If the quality is deemed insufficient (e.g. if the subset is too small, or if there are too many false positives), the subset might be sent back into the annotation module for a repeated ranking procedure. This can then be repeated until quality control is passed.

The training dataset is then generated. The training dataset can be used, for example, to train a classification network by using the output training dataset. In other words, the generated training dataset can be put to use for a desired use case for which the sample dataset was representative. The training dataset can be further recalibrated and re-generated via the annotation module if the training of the classification neural network is not satisfactory.

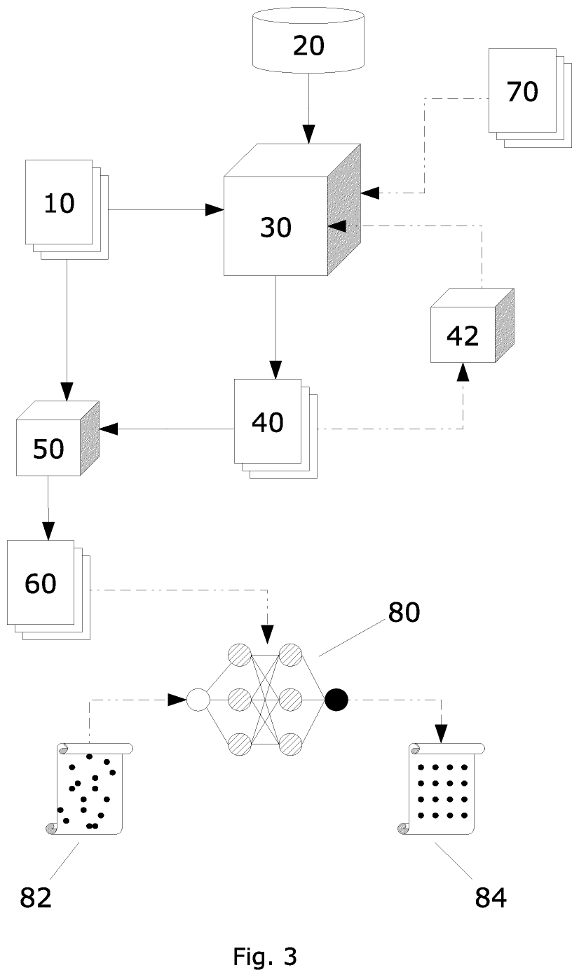

FIG. 3 schematically shows components and elements of a system for generating a training dataset according to an aspect of the present invention. Some components/elements are optional, represented by the dashed lines linking them to other elements of the system.

A sample dataset 10 can be input into an annotation module 30. The annotation module 30 may comprise a neural network-based algorithm or a different algorithm. The annotation module 30 has access to a benchmark dataset 20, which can e.g. be stored in a database (local and/or remote and/or distributed). The benchmark dataset 20 may be significantly larger than the sample dataset 10. It can also be significantly less structured and/or labeled and/or annotated. In other words, the benchmark dataset 20 can be an arbitrary large set of constituents some of which may be similar to constituents of the sample dataset 10.

Optionally, the annotation module 30 may also be configured to receive a negative dataset 70. The negative dataset 70 may indicate what type of data would be undesirable to have as part of the training dataset. In other words, the negative dataset 70 may be indicative of typical false positives or the like.

The annotation module can be configured to output a subset 40 of the benchmark dataset 20. This can be done by ranking the benchmark dataset 20 and selecting a part of it most similar to the sample dataset 10 (and optionally simultaneously not similar to the negative dataset 70).

The subset 40 may then optionally be directed to a quality control module 42. The quality control module 42 may verify whether the output subset 40 is of a high quality (e.g. that its constituents are indeed similar to the constituents of the sample dataset 10, that there are no false positives, that it is sufficiently large or the like). If the subset 40 is not found to have sufficient quality, it may be redirected back into the annotation module 30, where it can be used to further rank the benchmark dataset 20 and obtain a better-quality subset 40. There may also be some intervention by an operator during the quality control stage. For example, a person may review the output subset 40 to ensure that it is of an adequate quality.

The subset 40 may be input into a generator module 50, along with the sample dataset 10. The generator module 50 may combine the two so as to obtain a training dataset 60. The generator module 50 may also be implemented as part of the annotation module 30, and not as a separate module and/or subroutine. The training dataset 60 can be substantially larger than the sample dataset 10, but still be representative of its intention. In other words, if the sample dataset 10 comprised a few images of people's smiling faces, the training dataset 60 may now comprise millions of those images obtained from the benchmark dataset 20.

The training dataset 60 may optionally be used to train a classification neural network 80. The classification neural network 60 can then receive new unsorted input 72, and, based on its training via the training dataset 60, output a sorted output 74. For example, upon training the classification neural network 70 with a training dataset 60 comprising smiling human faces, it may then receive an input of arbitrary unlabeled images, and sort or classify them according to the likelihood of there being smiling faces on them.

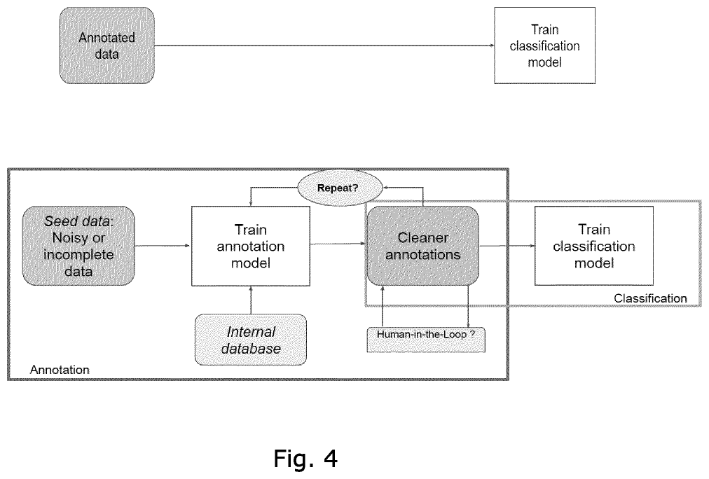

FIG. 4 schematically shows an advantage of the present proposed method and system compared to what has been commonly done in the art. Typically, an annotated clean, large dataset has been used to train a neural network. However, such “ideal” datasets can be difficult to obtain in real life. Therefore, the present method advantageously allows to start with seed data (also referred to as called sample dataset): a small and/or noisy set of data representing the parameters of what it is desired to train the neural network to classify.

The seed data can be input into the annotation model (referred to also as the annotation module). It can then be used to rank an internal database (also referred to as the benchmark dataset). This can then result in a subset of the internal database ranked similar to the seed data. The subset can be quality controlled, and the process optionally repeated to obtain better and better data corresponding to the parameters of the seed data. The data can be optionally reviewed by a human to ensure that the resulting training dataset is adequate. The improved training dataset can then be used to train a neural network, e.g. a classification neural network.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-15. (canceled)

16. A method for generating and using a dataset for training a classifier algorithm, the method comprising
Inputting a sample dataset into an annotation module;
The annotation module ranking a benchmark dataset based on the sample dataset;
Based on the ranking, the annotation module outputting a subset of the benchmark dataset ranked within a predetermined similarity threshold to the sample dataset;
Generating a training dataset by adding the subset of the benchmark dataset to the sample dataset;
A classification module using the training dataset to train the classifier algorithm.

17. The method according to claim 16 further comprising quality-controlling the output subset of the benchmark dataset prior to generating the training dataset.

18. The method according to claim 17 further comprising re-ranking the benchmark dataset and outputting a modified subset of the benchmark dataset if the quality-controlling fails.

19. The method according to claim 17 further comprising outputting a modified subset of the benchmark dataset by adjusting the predetermined similarity threshold if the quality-controlling fails.

20. The method according to claim 16 further comprising inputting the training dataset to the annotation module and repeating the ranking and output steps to output a second subset of the benchmark dataset and generate a second training set by combining the second subset of the benchmark dataset with the training set.

21. The method according to claim 16 further comprising additionally inputting a negative dataset into the annotation module.

22. The method according to claim 21 further comprising assigning lower rank to constituents of the benchmark dataset based on similarity to constituents of the negative dataset.

23. The method according to claim 21 further comprising simultaneously ranking the benchmark dataset based on the sample dataset and the negative dataset and removing any constituents of the output subset of the benchmark dataset ranking within a predetermined similarity threshold to the negative dataset.

24. The method according to claim 16 wherein the sample dataset constituents are at least partially annotated.

25. The method according to claim 24 wherein the method comprises using the annotations of the sample dataset as part of the ranking of the benchmark dataset.

26. The method according to claim 16 wherein the annotation module comprises a neural network and wherein the method further comprises the annotation module using a loss function to rank the benchmark dataset.

27. The method according to claim 26 wherein the method further comprises training the neural network on the sample dataset and using it to output the subset of the benchmark dataset once trained.

28. The method according to claim 26 wherein the loss function comprises a part configured to rank constituents of the benchmark dataset most similar to constituents of the sample dataset higher than the rest and a part configured to rank undesirable constituents as lower than the rest.

29. The method according to claim 28 wherein undesirable constituents are determined by their similarity to the negative dataset.

30. The method according to claim 16 wherein the classifier algorithm comprises a classification neural network and wherein the method further comprises training the classification neural network by using the generated training dataset and wherein the training comprises:
Inputting the training dataset into a classification neural network; and
Training the classification neural network to classify data based on the training dataset, and wherein the method further comprises retraining the classification neural network with the training dataset and a different loss function and comparing obtained results.

31. A system for generating and using a dataset for training a classifier algorithm, the system comprising
A database comprising at least a benchmark dataset;
An annotation module configured to
Receive a sample dataset;
Rank a benchmark dataset based on the sample dataset;
Based on the ranking, output a subset of the benchmark dataset ranked within a predetermined similarity threshold to the sample dataset;
Generate a training dataset by adding the subset of the benchmark dataset to the sample dataset; and
A classification module configured to use the training dataset to train the classifier algorithm.

32. The system according to claim 31 wherein
the annotation module is further configured to receive a negative dataset and reject candidates for subset of the benchmark dataset based on the negative dataset; and
the annotation module is further configured to simultaneously rank the benchmark dataset based on the sample dataset and the negative dataset and rank any constituents of the output subset of the benchmark dataset ranking within a predetermined similarity threshold to the negative dataset relatively lower than the constituents outside of the predetermined similarity threshold.

33. The system according to claim 31 wherein the classifier algorithm comprises a classification neural network and wherein the classification module is configured to:
Input the training dataset into the classification neural network; and
Train the classification neural network to classify data based on the training dataset; and
wherein the trained classification neural network is configured to classify new inputs.
